(19) United States
(12) Patent Application Publication
(10) Pub. No.: US 2006/0176688 A1
(43) Pub. Date: Aug. 10, 2006

(54) Portable multi-purpose electro-optical searchlight

(75) Inventor: Se Kit Yuen, Kwun Tong (HK)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: John Manufacturing Ltd.

(21) Appl. No.: 11/197,943

(22) Filed: Aug. 5, 2005

(30) Foreign Application Priority Data
Feb. 4, 2005 (HK) 05100961.0

(51) Int. Cl. F21L 4/02

(52) U.S. Cl. 362/184; 362/190; 362/199; 362/197

(57) ABSTRACT

The invention relates to a portable multi-purpose electro-optical searchlight, which includes: a housing provided with an inner cavity and a spotlight unit on one end thereof; and a power circuit device contained in the inner cavity of the housing and connected electrically with the spotlight unit. A SOS flash light column with adjustable illuminating angle and a superradiant LED lamp with adjustable illuminating angle are provided on one side of the housing. Two electro-optical cold-cathode fluorescent lamps with adjustable illuminating angles are provided on the other side of the housing. And supports with adjustable angles relative to the housing are rotatablely connected to the housing. The supports can be adjusted between different positions and fixed to any position. Said light sources can be adjusted respectively. Therefore, the searchlight can be adjusted by the user to realize an optimal illuminating angle.

### BACKGROUND OF THE INVENTION

1. Field of the Invention

The invention relates to a portable multi-purpose electro-optical searchlight, more particularly, to a hand-held searchlight.

2. Discussion of the Related Art

At present, many types of electro-optical searchlights, which are needed for a lot of outdoor activities in the dark, are well known. These searchlights have small volumes and are easy to be carried. However, the present electro-optical searchlights have only simple structures and can not be adjusted usually, thereby they must be hand-hold or fastened to corresponding components, such as work caps and the like, which restricts the person to use them in different circumstances.

Therefore, how to make an electro-optical searchlight not only have effective glow brightness, but also satisfy the user's need in different circumstances is always an object that the person skilled in the art wants to pursue.

Thus, the invention provides a new design for a portable multi-purpose electro-optical searchlight, which can be adjusted according to the actual usage circumstances and realize an effective illuminance.

### SUMMARY OF THE INVENTION

An object of the invention is to provide a new and improved design for a portable multi-purpose electro-optical searchlight, which includes a housing provided with five light sources, a hand grip and two supports. The hand grip and the housing are located in the same horizontal so as to be held by the user. The supports can rotate around a rotatable hinge to any position within an arc of at least 270°, so as to provide support for the housing. Thereby, the searchlight may be placed on a plane and realize an optimal illuminating angle.

Specifically, the present invention provides a portable multi-purpose electro-optical searchlight, which includes: a housing provided with an inner cavity. and a spotlight unit on one end thereof, and a power circuit device contained in the inner cavity of the housing and connected electrically with the spotlight unit. A SOS flash light column with adjustable illuminating angle and a superradiant LED lamp with adjustable illuminating angle are provided on one side of the housing. Two electro-optical cold-cathode fluorescent lamps with adjustable illuminating angles are provided on the other side of the housing. And supports with adjustable angles relative to the housing are rotatablely connected to the housing.

In the above mentioned portable multi-purpose electro-optical searchlight, a rectangular cylinder hand grip is provided on the housing.

In the above mentioned portable multi-purpose electro-optical searchlight, at least one switching button, at least one receptacle for outer power supply and at least one power supply are provided in the inner cavity of the housing.

In the above mentioned portable multi-purpose electro-optical searchlight, the spotlight unit includes at least one bulb and a reflector with a cambered surface.

In the above mentioned portable multi-purpose electro-optical searchlight, the supports include a long support and a short support, and the long support and the short support can rotate around corresponding rotatable hinges respectively and serve as adjustable support for the housing.

In the above mentioned portable multi-purpose electro-optical searchlight, the supports are fastened by locking or loosening lock elements.

In the above mentioned portable multi-purpose electro-optical searchlight, the short support is provided on the long support and connected with the housing via the long support.

In the above mentioned portable multi-purpose electro-optical searchlight, an end of each of the two electro-optical cold-cathode fluorescent lamps with adjustable illuminating angles is connected with a rotation-connection element respectively so that the two electro-optical cold-cathode fluorescent lamps can be folded together in parallel with each other.

In the above mentioned portable multi-purpose electro-optical searchlight, the angles of said SOS flash light column, superradiant LED lamp and electro-optical cold-cathode fluorescent lamps are adjusted with rotation-connection components, each of which includes: a coupling joint and an annular fastening-guide member, wherein the coupling joint has a circumferential surface on which gear teeth are provided; the annular fastening-guide member has a circumferential surface matching with the circumferential surface of the coupling joint; at least one engaging tooth engaging with the gear teeth is provided on the circumferential surface of the annular fastening-guide member.

Each of the light sources and supports of the portable multi-purpose electro-optical searchlight according to the invention can be adjusted by the user on the basis of the actual needs, so that it can achieve an optimal illuminating angle, while providing enough illuminance.

### BRIEF DESCRIPTION OF THE DRAWINGS

The preferred embodiment of the present invention will now be described in detail with reference to the Figures so as to illustrate the other features of the invention.

FIG. 1 shows a front view of the portable multi-purpose electro-optical searchlight according to the invention;

FIG. 2 shows a longitudinal section view of the portable multi-purpose electro-optical searchlight shown in FIG. 1;

FIG. 3 shows a top view of the portable multi-purpose electro-optical searchlight shown in FIG. 1;

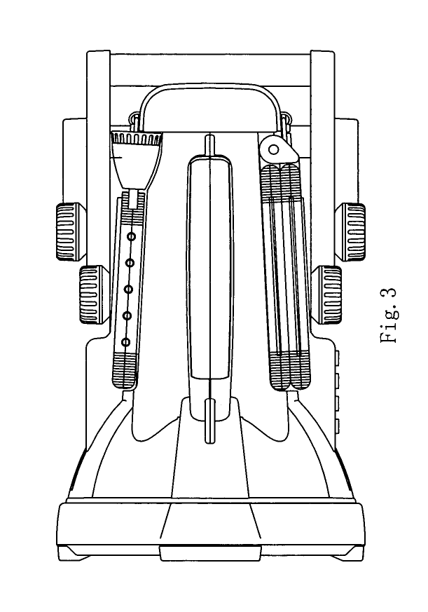

FIG. 4 shows a bottom view of the portable multi-purpose electro-optical searchlight shown in FIG. 1;

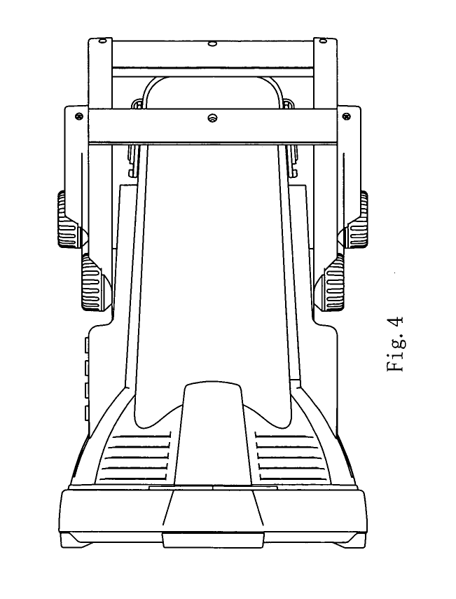

FIG. 5 shows a left view of the portable multi-purpose electro-optical searchlight shown in FIG. 1;

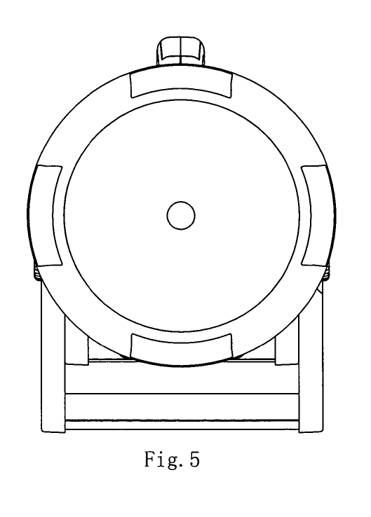

FIG. 6 shows a right view of the portable multi-purpose electro-optical searchlight shown in FIG. 1;

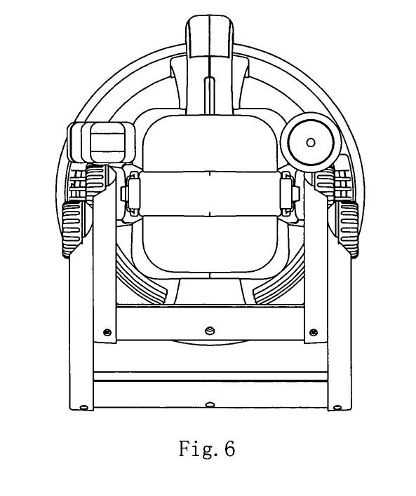

FIG. 7 shows a rear view of the portable multi-purpose electro-optical searchlight shown in FIG. 1;

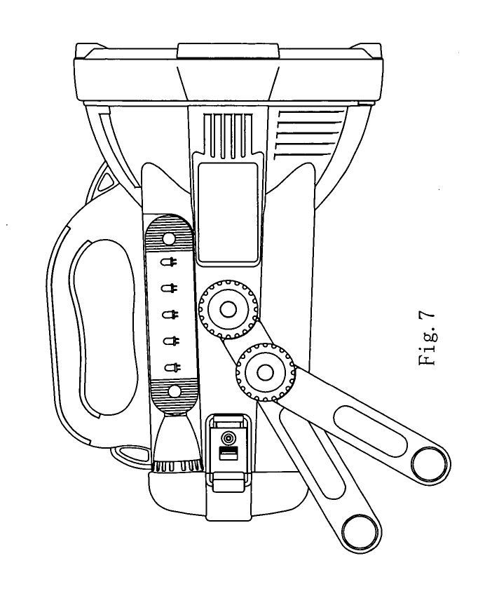

FIG. 8 shows a perspective view of the portable multi-purpose electro-optical searchlight shown in FIG. 1;

FIG. 9 shows a front view of the portable multi-purpose electro-optical searchlight shown in FIG. 1 in another state, wherein the angle between each of the two electro-optical cold-cathode fluorescent lamps with adjustable illuminating angles and the housing is 90°;

FIG. 10 shows a left view of the portable multi-purpose electro-optical searchlight shown in FIG. 1 in another state, wherein the angle between one of the two electro-optical cold-cathode fluorescent lamps with adjustable illuminating angles and the housing is 90°, and the relative angle between the two electro-optical cold-cathode fluorescent lamps is 180° and 270°;

FIG. 11 shows a rear view of the portable multi-purpose electro-optical searchlight shown in FIG. 1 in another state, wherein the angle between the SOS flash light column and the housing is 90°, and the relative angle between the superradiant LED lamp and the SOS flash light column is 90°, 180° and 270°;

FIG. 12 shows an exploded perspective view of the portable multi-purpose electro-optical searchlight shown in FIG. 1;

FIG. 13 shows an exploded perspective view which illustrates the connection relationship of the SOS flash light column and the housing in the portable multi-purpose electro-optical searchlight shown in FIG. 1;

FIG. 14 shows an exploded perspective view which illustrates the connection relationship of the SOS flash light column and the superradiant LED lamp in the portable multi-purpose electro-optical searchlight shown in FIG. 1;

FIG. 15 shows an exploded perspective view which illustrates the connection relationship of one of the electro-optical cold-cathode fluorescent lamps and the housing in the portable multi-purpose electro-optical searchlight shown in FIG. 1 (some parts have been omitted); and

FIG. 16 shows an exploded perspective view which illustrates the connection relationships of the electro-optical cold-cathode fluorescent lamps and the rotation-connection element in the portable multi-purpose electro-optical searchlight shown in FIG. 1.

### DETAILED DESCRIPTION OF THE INVENTION

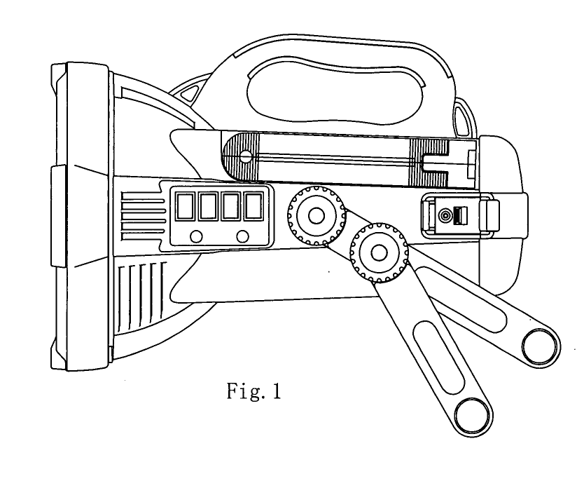

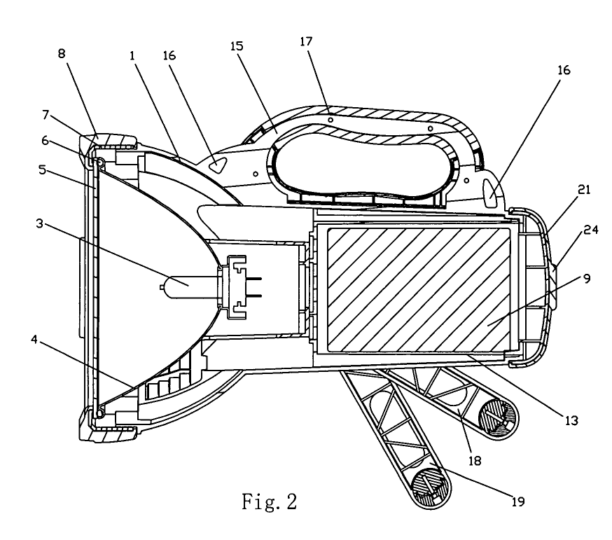

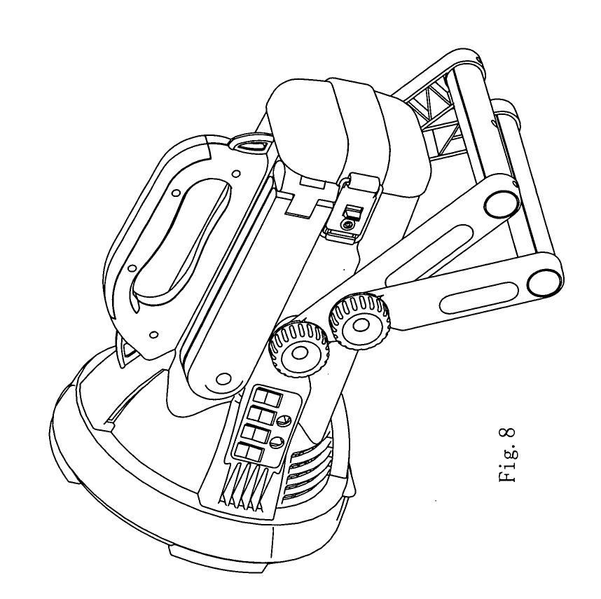

Please refer to FIG. 1, 3˜7, which show a front view, a top view, a bottom view, a left view, a right view and a rear view of the portable multi-purpose electro-optical searchlight according to the invention respectively. FIG. 2 shows a longitudinal section view of the portable multi-purpose electro-optical searchlight shown in FIG. 1; and FIG. 8 shows a perspective view of the portable multi-purpose electro-optical searchlight shown in FIG. 1.

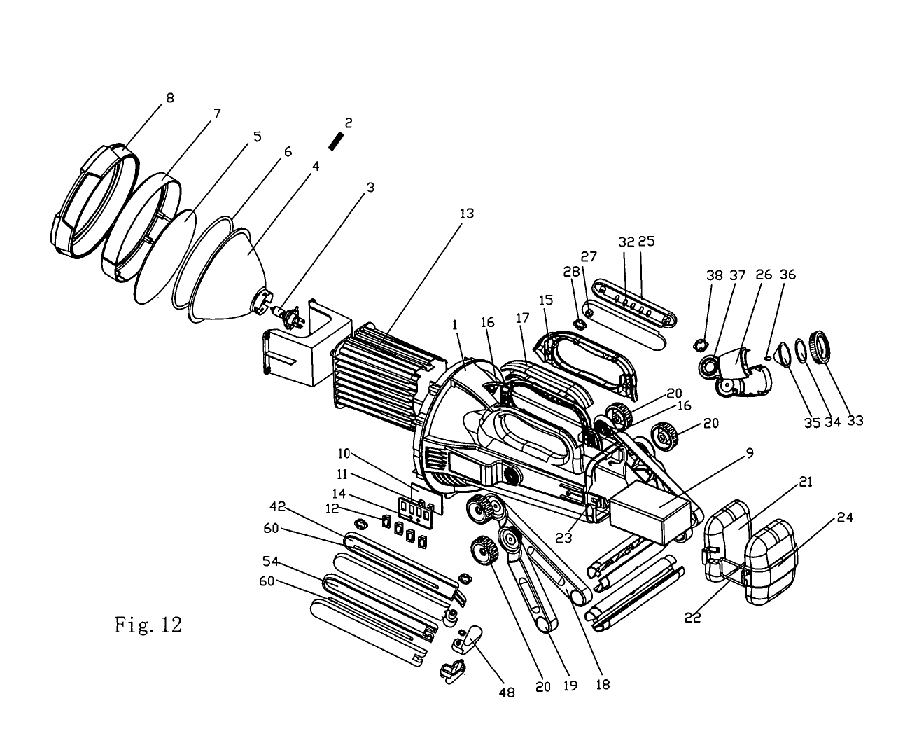

Referring to FIG. 2 and FIG. 12, the portable multi-purpose electro-optical searchlight according to the invention has a housing 1 with a rectangular or circular cylinder shape. A spotlight unit 2 is provided on the front end of the housing 1 and includes a bulb 3, a reflector with a cambered surface and a front panel 5 made of glass or other transparent material. The reflector with a cambered surface is usually a reflecting mirror 4 with a paraboloid shape. A sealing ring 6 seals the inner side of the front panel 5 and the outer end face of the reflecting mirror 4. A front annular light cap 7 is fastened to the front end of the housing 1 in a detachable manner. An annular shockproof cap 8 made of rubber or other plastic material is fastened to the front end of the light cap 7 in a detachable manner, so that the electro-optical searchlight can sustain external shocks.

As shown in the figures, the bulb 3 of the spotlight unit 2 is powered by a power supply 9 in the housing 1. The power supply 9 is electrically connected with a power circuit device 10, a receptacle 11 for outer power supply and a switching button 12 in the housing 1 via electrical wires. Thus, the light source, i.e. the bulb 3, can be operated by connecting electrically with the external power supply. It is apparent that the bulb 3 can be powered by batteries, which can be rechargeable batteries.

The power source 9 is provided in a battery protecting box 13, so that the power source 9 can sustain external shocks.

The receptacle 11 for outer power supply is attached to the inner surface of an external plughole element 14 of the housing 1.

The hand grip 15 has an almost rectangular cylinder shape and is fixedly connected with the housing 1, so that the user can hold the portable multi-purpose electro-optical searchlight comfortably. Belt buckles 16 are provided on the left and right ends of the hand grip 15, so that the user can carry the searchlight with a baldric. Grasping elements 17 made of rubber or other plastic material are provided on the upper and lower sides of the hand grip 15, so that the user can hold the hand grip 15 more comfortably.

A long support 18 and a short support 19 are connected rotatablely with the housing 1, and can be tightly fixed at any needed position by adjusting lock elements 20. The long support 18 and the short support 19 can rotate around a rotatable hinge to any position within an arc of at least 270°, so as to provide the housing with changeable support within an arc of at least 270° according to the requirements, and thereby realize an optimal illuminating angle. For example, the adjusted supports may be placed on a plane and serve as a fixed power source. If the two supports are adjusted to form an angle more than 90°, the portable multi-purpose electro-optical searchlight may also be placed on a shoulder of the user to illuminate at long distances.

A battery cover 21 is provided on the rear end of the housing 1 with flexible connection. Metal buckles 22 are provided on two side ends of the battery cover 21 and buckled with an active lock 23 which is fixedly connected with the rear end of the housing 1. When the active lock 23 is pushed, the metal buckles 22 are not tightly buckled onto the housing 1. Thus the battery cover 21 can be detached from the housing 1, so that the user can change the batteries. A tail cover shockproof cap 24 made of rubber or other plastic material is fastened on the surface of the battery cover 21 in a detachable manner, so that the portable multi-purpose electro-optical searchlight can sustain external shocks.

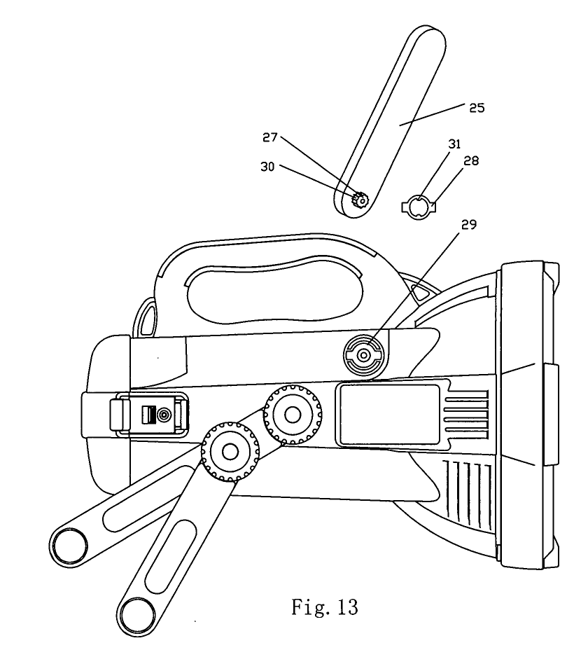

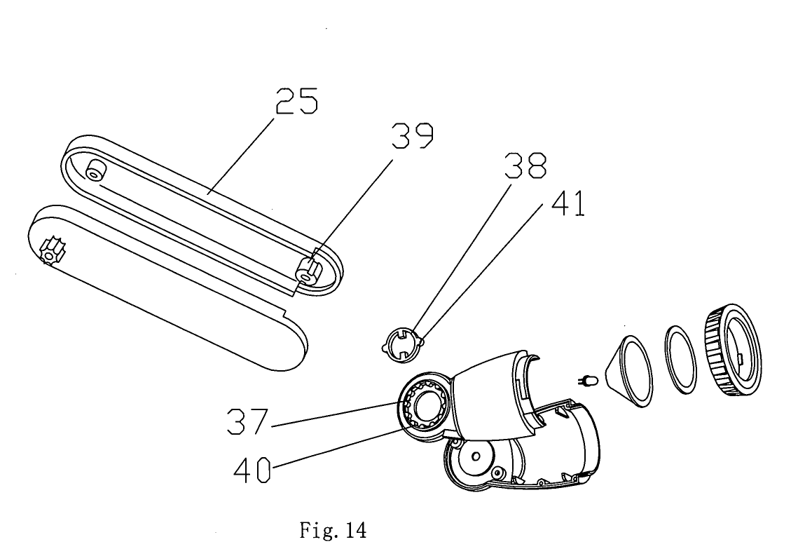

A SOS flash light column 25 with adjustable illuminating angle and a superradiant LED lamp 26 with adjustable illuminating angle are provided on one side of the housing 1. The SOS flash light column 25 can be a LED SOS flash light column and has a rectangular cylinder shape. The SOS flash light column 25 is connected rotatablely with the housing 1 and its casing is made of glass or other transparent material. The angle between the SOS flash light column 25 and the superradiant LED lamp 26 is adjusted with rotation-connection components. As shown in FIG. 13, a coupling joint 27 is fastened on one end of the SOS flash light column 25, and an elastic annular fastening-guide member 28 is fixedly provided on a joint axle 29 on a side of the housing 1, wherein the joint axle 29 on the housing 1 and the annular fastening-guide member 28 are inserted rotatablely into gear teeth 30 of the coupling joint 27. At least one engaging tooth 31 is extended from the outer circumferential surface of the annular fastening-guide member 28 for engaging with several gear teeth 30 selectively, so that the rotational position of the SOS flash light column 25 relative to the housing 1 can be fixed. The gear teeth 30 are formed uniformly on the outer circumferential surface of the coupling joint 27. The SOS flash light column 25 is connected rotatablely with the joint axis 29 of the housing 1 by the coupling joint 27, so that the angle between the housing 1 and the SOS flash light column 25 can be adjusted by rotating. Thus, the illuminating angle of the light source can be adjusted by the SOS flash light column 25. There are five (or other number of ) LEDs 32 provided in the SOS flash light column 25 to emit flashing SOS light. The superradiant LED lamp 26 with adjustable angle is connected rotatablely to the other end of the SOS flash light column 25. The superradiant LED lamp 26 includes a light cap 33, a panel 34 made of glass or other transparent material, a reflecting mirror 35 usually with a paraboloid shape, and a superradiant LED bulb 36. As shown in FIG. 14, a coupling joint 37 and an elastic annular fastening-guide member 38 are provided on one end of the supreradiant LED lamp 26, and the elastic annular fastening-guide member 38 is fastened to a joint axle 39 on this end of the SOS flash light column 25. The joint axle 39 of the SOS flash light column 25 and the annular fastening-guide member 38 are inserted rotatablely into gear teeth 40 of the coupling joint 37. At least one engaging tooth 40 is extended from the outer circumferential surface of the annular fastening-guide member 38 for engaging with several gear teeth 40 selectively, so that the rotational position of the SOS flash light column 25 relative to the superradiant LED lamp 26 can be fixed. The gear teeth 40 are formed uniformly on the inner circumferential surface of the coupling joint 37. The superradiant LED lamp 26 is connected rotatablely with the joint axle 39 of the SOS flash light column 25 via the coupling joint 37, so as to adjust rotatably the angle between the superradiant LED lamp 26 and the SOS flash light column 25 and thereby adjust the illuminating angle of the light sources.

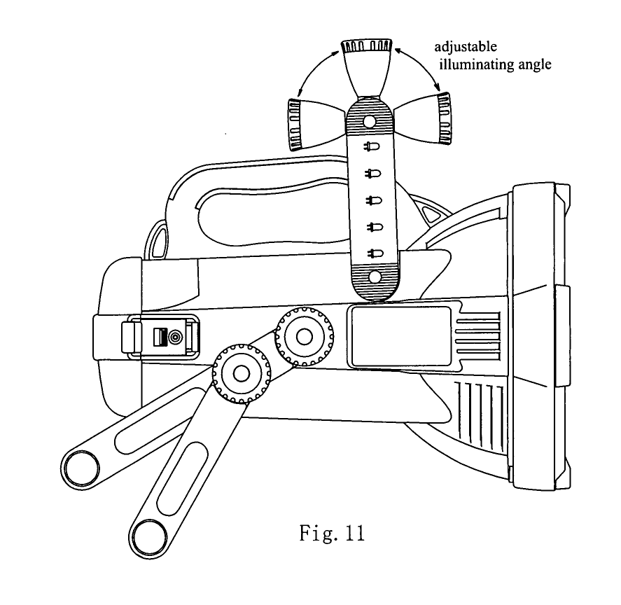

Please also refer to FIG. 11, which shows a rear view of the portable multi-purpose electro-optical searchlight shown in FIG. I in another state, wherein the angle between the SOS flash light column 25 and the housing is 90°, and the relative angle between the superradiant LED lamp 26 and the SOS flash light column 25 is 90°, 180° and 270°.

An electro-optical cold-cathode fluorescent lamp 42 with adjustable illuminating angle is provided on the other side of the housing I and connected with another electro-optical cold-cathode fluorescent lamp 54 side by side. The electro-optical cold-cathode fluorescent lamps 42, 54 have rectangular cylinder shapes and their casings are made of glass or other transparent material. In addition, the electro-optical cold-cathode fluorescent lamps 42, 54 are connected rotatablely with the housing 1.

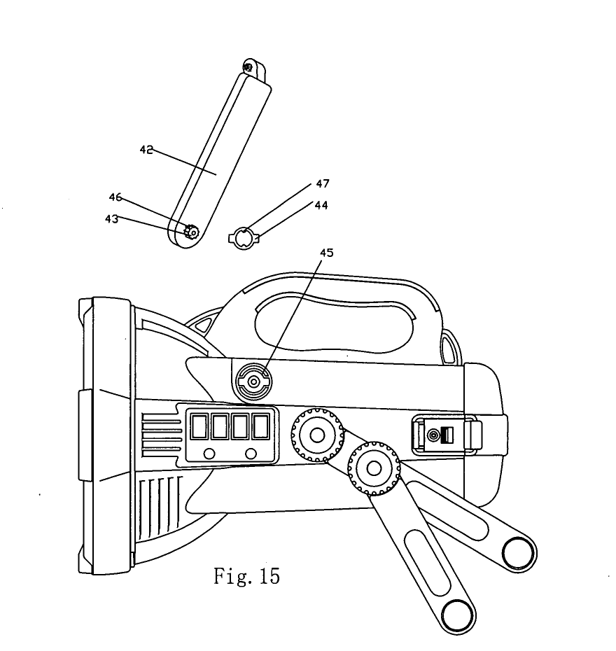

As shown in FIG. 15, a coupling joint 43 is fixed on one end of the electro-optical cold-cathode fluorescent lamp 42, and an elastic annular fastening-guide member 44 is fastened on a joint axle 45 on the other side of the housing 1, wherein the joint axle 45 of the housing 1 and the annular fastening-guide member 44 are inserted rotatablely into gear teeth 46 of the coupling joint 43. At least one engaging tooth 47 is extended from the inner circumferential surface of the annular fastening-guide member 44 for engaging with some gear teeth 46 selectively, so that the rotational position of the electro-optical cold-cathode fluorescent lamp 42 relative to the housing 1 can be fixed. The gear teeth 46 are formed uniformly on the outer circumferential surface of the coupling joint 43. The electro-optical cold-cathode fluorescent lamp 42 is connected rotatablely with the joint axle 45 on the housing 1 by means of the coupling joint 43, so that the angle between the housing I and the electro-optical cold-cathode fluorescent lamp 42 can be adjusted rotatablely. Thereby the illuminating angle of the light source can be adjusted. In FIG. 15, some components connected with the electro-optical cold-cathode fluorescent lamp 42 are omitted for showing the connection relationship more clearly.

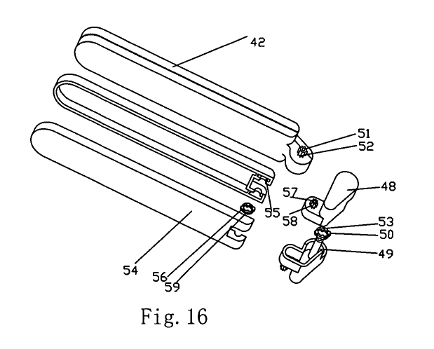

The other end of the electro-optical cold-cathode fluorescent lamp 42 is connected with one end of the electro-optical cold-cathode fluorescent lamp 54 via a rotation-connection component. FIG. 16 is an exploded perspective view which shows the other end of the electro-optical cold-cathode fluorescent lamp 42 is connected to one end of a rotation-connection element 48, the other end of the rotation-connection element 48 is connected with the electro-optical cold-cathode fluorescent lamp 54, and the electro-optical cold-cathode fluorescent lamps 42, 54 are connected rotatablely with the rotation-connection element 48 respectively. As shown in FIG. 16, a joint axle 49 is fixed on one end of the rotation-connection element 48 and an elastic annular fastening-guide member 50 is fixed on the joint axle 49 of the rotation-connection element 48. The annular fastening-guide member 50 is inserted rotatablely into gear teeth 52 of a coupling joint 51 on the electro-optical cold-cathode fluorescent lamp 42. At least one engaging tooth 53 is extended from the inner circumferential surface of the annular fastening-guide member 50 for engaging with several gear teeth 52 selectively, so that the rotational position of the electro-optical cold-cathode fluorescent lamp 42 relative to the rotation-connection element 48 can be fixed. The gear teeth 52 are formed uniformly on the outer circumferential surface of the coupling joint 51. The electro-optical cold-cathode fluorescent lamp 42 is connected rotatablely with the joint axle 49 of the rotation-connection element 48 via the coupling joint 51, so that the angle between the rotation-connection element 48 and the electro-optical cold-cathode fluorescent lamp 42 can be adjusted rotatablely. And the other end of the rotation-connection 48 is connected rotatablely with another electro-optical cold-cathode fluorescent lamp 54. As shown in FIG. 16, a connecting hole 55 is provided on one end of the electro-optical cold-cathode fluorescent lamp 54. An elastic fastening-guide element 56 is fixed in the connecting hole 55. An annular fastening-guide element 56 is inserted rotatablely into gear teeth 58 of the coupling joint 57 on the rotation-connection element 48. At least one engaging tooth 59 is extended from the inner circumferential surface of the annular fastening-guide member 56 for engaging with several gear teeth 58 selectively, so that the rotational position of the electro-optical cold-cathode fluorescent lamp 54 relative to the rotation-connection element 48 can be fixed. The gear teeth 58 are formed uniformly on the outer circumferential surface of the coupling joint 57. The rotation-connection element 48 is connected rotatablely with the connecting hole 55 of the electro-optical cold-cathode fluorescent lamp 54 via the coupling joint 57, so that the angle between the rotation-connection element 48 and the electro-optical cold-cathode fluorescent lamp 54 is adjusted rotatablely. Thereby the illuminating angle of the light source can be adjusted. An energy-saving cold-cathode fluorescent luminous tube 60 is provided in the electro-optical cold-cathode fluorescent lamps 42 and 54 respectively.

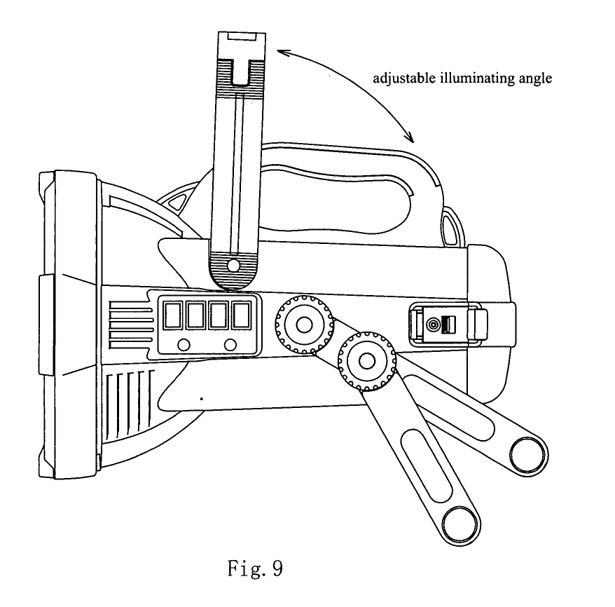

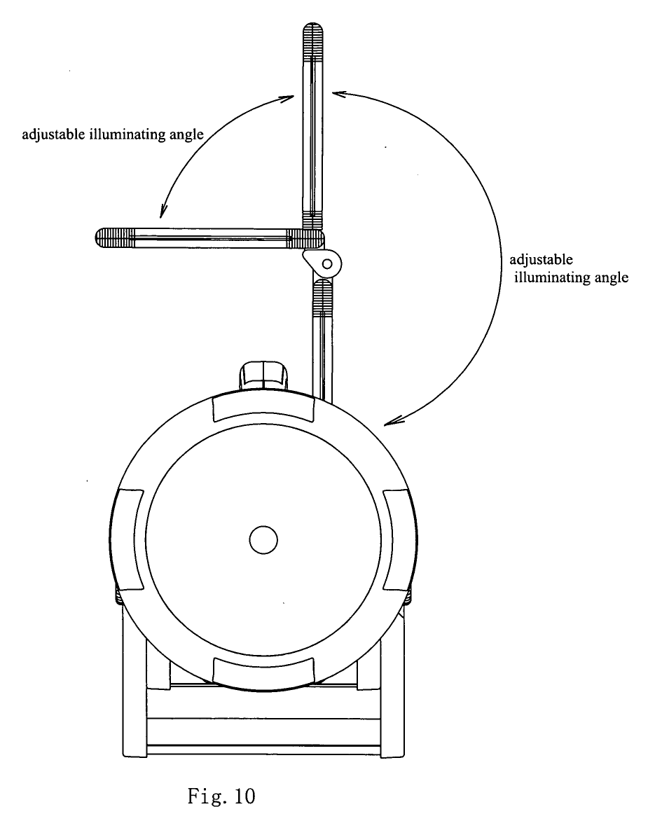

Please refer to FIG. 9 and FIG. 10. FIG. 9 shows a front view of the portable multi-purpose electro-optical searchlight shown in FIG. I in another state, wherein the angles between the two electro-optical cold-cathode fluorescent lamps 42, 54 with adjustable illuminating angles and the housing 1 are both 90°; FIG. 10 shows a left view of the portable multi-purpose electro-optical searchlight shown in FIG. 1 in another state, wherein the angle between the electro-optical cold-cathode fluorescent lamp 42 with adjustable illuminating angle and the housing 1 is 90°, and the relative angle between the electro-optical cold-cathode fluorescent lamp 42 and the other electro-optical cold-cathode fluorescent lamp 54 is 180° and 270°.

Based on the above structure, the portable multi-purpose electro-optical searchlight according to the invention can be supported firmly on a supporting plane such as a table top and ground surface for illuminating, and may be used as a table lamp without being grasped by the user. Furthermore, several light sources are provided on the different sides of the searchlight, which can be used flexibly according to the user's requirements.

The luminosity of the portable multi-purpose electro-optical searchlight according to the invention can reach the energy of 10,000,000 candelas. Each of the SOS flash light column with adjustable lighting angle, superradiant LED lamp with adjustable lighting angle and two electro-optical cold-cathode fluorescent lamps with adjustable lighting angles may be an energy saving lamp. The searchlight can also be used to illuminate in the field. The portable multi-purpose electro-optical searchlight adapts specially to the army against terrorism, aeroamphibious army, police, fire protection, urgently saving, discipline army, traffic vessel, train and important superradiant light source for civil use; and it is absolutely necessary for emergency at home.

What is claimed is:

1. A portable multi-purpose electro-optical searchlight, which includes:
a housing (1) provided with an inner cavity and a spotlight unit (2) on one end thereof; and
a power circuit device (10) contained in the inner cavity of the housing (1) and connected electrically with the spotlight unit (2);
wherein a SOS flash light column (25) with adjustable illuminating angle and a superradiant LED lamp (26) with adjustable illuminating angle are provided on one side of the housing (1); two electro-optical cold-cathode fluorescent lamps (42, 54) with adjustable illuminating angles are provided on the other side of the housing (1); and
supports (18, 19) with adjustable angles relative to the housing (1) are rotatablely connected to the housing (1).

2. The portable multi-purpose electro-optical searchlight according to claim 1, wherein a rectangular cylinder hand grip (15) is provided on the housing (1).

3. The portable multi-purpose electro-optical searchlight according to claim 1, wherein at least one switching button (12), at least one receptacle (11) for outer power supply and at least one power supply are provided in the inner cavity of the housing (1).

4. The portable multi-purpose electro-optical searchlight according to claim 1, wherein the spotlight unit (2) includes at least one bulb (3) and a reflector (4) with a cambered surface.

5. The portable multi-purpose electro-optical searchlight according to claim 1, wherein the supports (18, 19) include a long support (18) and a short support (19), and the long support (18) and the short support (19) can rotate around corresponding rotatable hinges respectively and serve as adjustable support for the housing (1).

6. The portable multi-purpose electro-optical searchlight according to claim 5, wherein the supports (18, 19) are fastened by locking or loosening lock elements (20).

7. The portable multi-purpose electro-optical searchlight according to claim 5, wherein the short support (19) is provided on the long support (18) and connected with the housing (1) via the long support (18).

8. The portable multi-purpose electro-optical searchlight according to claim 6, wherein the short support (19) is provided on the long support (18) and connected with the housing (1) via the long support (18).

9. The portable multi-purpose electro-optical searchlight according to claim 1, wherein an end of each of the two electro-optical cold-cathode fluorescent lamps (42, 54) with adjustable illuminating angles is connected with a rotation-connection element (48) respectively so that the two electro-optical cold-cathode fluorescent lamps can be folded together in parallel with each other.

10. The portable multi-purpose electro-optical searchlight according to claim 1, wherein the angles of said SOS flash light column (25), said superradiant LED lamp (26) and said electro-optical cold-cathode fluorescent lamps (42, 54) are adjusted respectively with rotation-connection components, each of which includes: a coupling joint (27, 37, 43, 51, 57) and an annular fastening-guide member (28, 38, 44, 50, 56), wherein the coupling joint (27, 37, 43, 51, 57) has a circumferential surface on which gear teeth (30, 40,46, 52, 58) are provided, the annular fastening-guide member (28, 38, 44, 50, 56) has a circumferential surface matching with the circumferential surface of the coupling joint (27, 37, 43, 51, 57), and at least one engaging tooth (31, 41, 47, 53, 59) engaging with the gear teeth (30, 40, 46, 52, 58) are provided on the circumferential surface of the annular fastening-guide member (28, 38, 44, 50, 56).

11. The portable multi-purpose electro-optical searchlight according to claim 9, wherein the angles of said SOS flash light column (25), said superradiant LED lamp (26) and said electro-optical cold-cathode fluorescent lamps (42, 54) are adjusted respectively with rotation-connection components, each of which includes: a coupling joint (27, 37, 43, 51, 57) and an annular fastening-guide member (28, 38, 44, 50, 56), wherein the coupling joint (27, 37, 43, 51, 57) has a circumferential surface on which gear teeth (30, 40, 46, 52, 58) are provided, the annular fastening-guide member (28, 38, 44, 50, 56) has a circumferential surface matching with the circumferential surface of the coupling joint (27, 37, 43, 51, 57), and at least one engaging tooth (31, 41, 47, 53, 59) engaging with the gear teeth (30, 40, 46, 52, 58) are provided on the circumferential surface of the annular fastening-guide member (28, 38, 44, 50, 56).
